(19) United States
(12) Patent Application Publication
(10) Pub. No.: US 2026/0192312 A1
(43) Pub. Date: Jul. 9, 2026

(54) SPRINKLER STRUCTURE WITH MULTI-STAGE WATER CONTROL

(71) Applicant: AQUALEAN MANUFACTURING ASSOCIATES CO., LTD., Taipei City (TW)

(72) Inventors: Pin-Hsien YU, Taipei City (TW); Kai-Yuan CHEN, Taipei City (TW)

(21) Appl. No.: 19/556,084

(22) Filed: Mar. 4, 2026

Related U.S. Application Data
(63) Continuation-in-part of application No. 18/590,330, filed on Feb. 28, 2024.

(51) Int. Cl. B05B 3/04; B05B 12/00

(52) U.S. Cl. CPC B05B 3/0438; B05B 12/002

(57) ABSTRACT

A sprinkler structure with multi-stage water control includes a base, an oscillation controller connected to a water supply to generate reciprocating oscillation, and a water spray assembly driven by the oscillation controller. The water spray assembly is provided with a plurality of nozzles and defines a main chamber and multiple sectional chambers, each communicating with a plurality of adjacent nozzles. A plurality of sectional control valves are disposed between the main chamber and the sectional chambers, each selectively controlling water communication therebetween, thereby enabling sectional multi-stage water discharge control to satisfy diversified spraying requirements.

### CROSS-REFERENCE TO RELATED APPLICATIONS

The present application is a continuation-in-part of U.S. Patent Application No. 18/590,330, filed on February 28, 2024, entitled "SPRINKLER STRUCTURE WITH MULTI-STAGE WATER CONTROL", the entire disclosure of which is hereby incorporated by reference in its entirety.

### FIELD OF THE INVENTION

The present invention relates to a sprinkler, and more particularly to a sprinkler structure with multi-stage water control.

### BACKGROUND OF THE INVENTION

Conventional sprinklers generally include a spray tube provided with a plurality of nozzles. The spray tube is operatively coupled to an oscillation controller such that, when water is introduced under pressure, the oscillation controller drives the spray tube to perform reciprocating oscillating motion, thereby enabling the sprayed water to vary its discharge angle.

In order to satisfy diversified usage requirements, certain conventional sprinklers are further configured with a control valve disposed at each nozzle for independently adjusting spray modes. However, such sprinkler structures have been found to exhibit inherent drawbacks in practical applications. Specifically, the installation of individual control valves necessitates careful consideration of water sealing performance, thereby increasing the risk of water leakage. When an excessive number of control valves are provided, the sprinkler is prone to reduced service life due to low utilization efficiency and leakage issues associated with sealing rings. Moreover, the spatial requirements for accommodating the control valves inevitably increase the spacing between adjacent nozzles, resulting in a reduced nozzle distribution density and adversely affecting spray uniformity. These issues constitute significant technical challenges that merit further investigation and improvement within the industry.

### SUMMARY OF THE INVENTION

The primary objective of the present invention is to provide a sprinkler structure with multi-stage water control.

To achieve the foregoing objective, the present invention provides the following technical solution.

A sprinkler structure with multi-stage water control, comprising a base. An oscillation controller is detachably connected to the base and connected to an inlet connector configured to connect to a water supply conduit for introducing a water flow, the oscillation controller being configured to generate a reciprocating oscillation by utilizing water pressure of the water flow. A water spray assembly is provided having a first end assembled to and driven by the oscillation controller and a second end pivotally connected to the base, the water spray assembly being provided with a plurality of nozzles spaced along an extending direction thereof. The water spray assembly defines a main chamber, one end of the main chamber communicating with the inlet connector through the oscillation controller, and a plurality of sectional chambers spaced along the extending direction of the water spray assembly, each sectional chamber communicating with a plurality of adjacent nozzles. A plurality of sectional control valves are respectively disposed on the water spray assembly, each sectional control valve being located between the main chamber and a corresponding one of the sectional chambers, such that each sectional control valve selectively controls fluid communication between the corresponding sectional chamber and the main chamber, thereby achieving sectional multi-stage water control.

The primary effect and advantage of the present invention reside in that each sectional control valve independently controls fluid communication between one sectional chamber and the main chamber, thereby enabling sectional multi-stage water control, satisfying diversified usage requirements while exhibiting notable practical advancement.

### BRIEF DESCRIPTION OF DRAWINGS

FIG. 1 is a perspective view of Embodiment 1 of the present invention.

FIG. 2 is a partially exploded perspective view of Embodiment 1 of the present invention.

FIG. 3 is a top view of an oscillation controller, a water spray assembly, and an inlet connector of Embodiment 1 of the present invention.

FIG. 4 is a cross-sectional view taken along line 4-4 of FIG. 3.

FIG. 5 is an enlarged view of a cross-section taken along line 5-5 of FIG. 4, illustrating a sectional control valve in an open state.

FIG. 6 is a cross-sectional view of the water spray assembly in use according to Embodiment 1 of the present invention, illustrating the sectional control valve in a closed state.

FIG. 7 is a front view of the water spray assembly in use according to Embodiment 1 of the present invention, illustrating a spraying state in which some sectional control valves are open while others are closed.

FIG. 8 is a partially exploded perspective view of Embodiment 2 of the present invention.

FIG. 9 is a top view of an oscillation controller, a water spray assembly, and an inlet connector of Embodiment 2 of the present invention.

FIG. 10 is a cross-sectional view of the water spray assembly of Embodiment 2 of the present invention.

### DETAILED DESCRIPTION OF THE INVENTION

The drawings illustrate embodiments of a sprinkler structure with multi-stage water control according to the present invention. The illustrated embodiments are provided for purposes of explanation and description only and are not intended to limit the scope of the present invention as defined by the appended claims

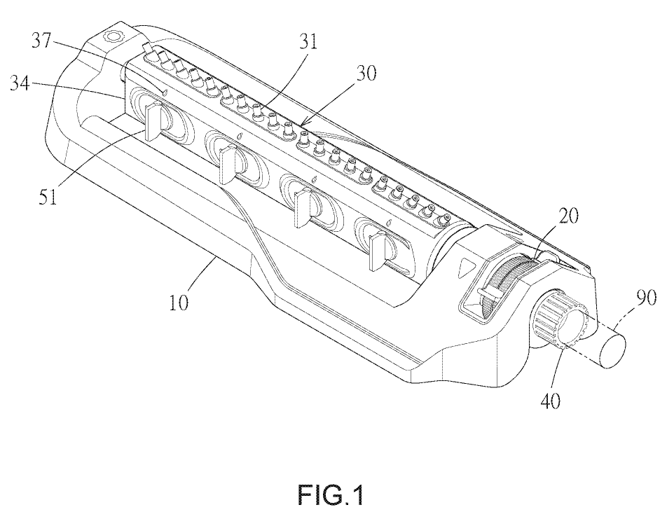

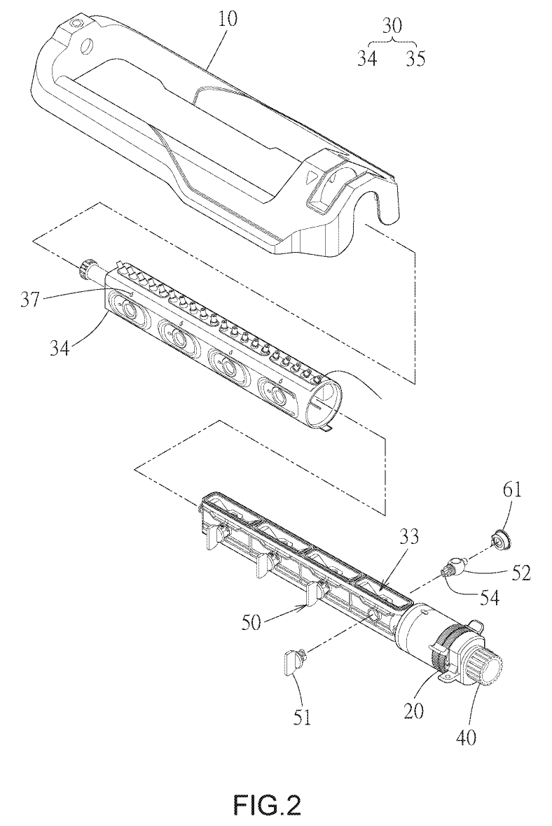

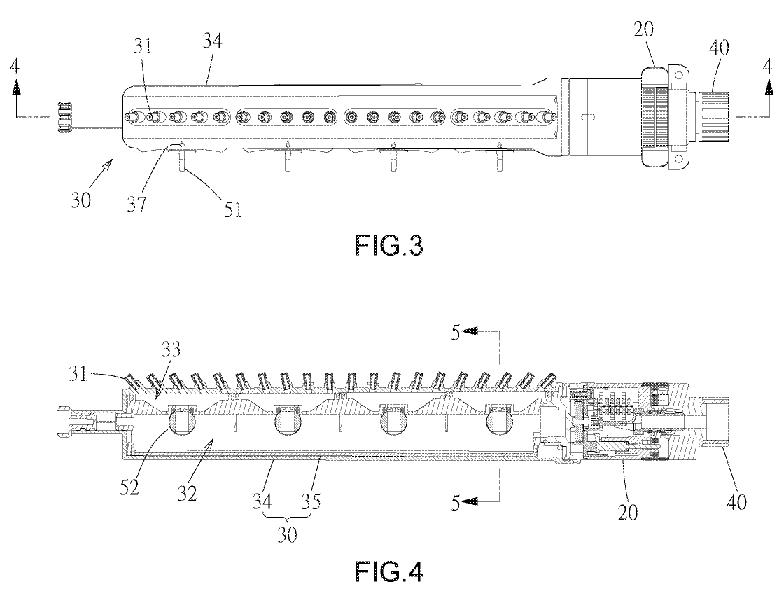

As shown in FIGS. 1 through 6, Embodiment 1 of the sprinkler structure with multi-stage water control according to the present invention comprises a base 10, an oscillation controller 20, a water spray assembly 30, and a plurality of sectional control valves 50. The oscillation controller 20 is detachably connected to the base 10 and is connected to an inlet connector 40 for connection with a water supply conduit 90 so as to introduce a water flow. The oscillation controller 20 is configured to reciprocatingly rotate by utilizing water pressure of the water flow. The oscillation controller 20 may be a conventional structure known to those skilled in the art and operates by converting water pressure into a reciprocating oscillatory motion for driving the water spray assembly 30; therefore, a detailed description of its internal structure is omitted herein for brevity.

The water spray assembly 30 is an elongated structure having one end assembled to and driven by the oscillation controller 20 and an opposite end pivotally connected to the base 10. The water spray assembly 30 is provided with a plurality of nozzles 31 spaced along an extending direction thereof. The water spray assembly 30 defines a main chamber 32, one end of which communicates with the inlet connector 40 through the oscillation controller 20. A plurality of sectional chambers 33 are spaced along the extending direction of the water spray assembly 30, wherein each sectional chamber 33 communicates with a plurality of adjacent nozzles 31.

Each sectional control valve 50 is disposed on the water spray assembly 30 and is located between the main chamber 32 and a corresponding one of the sectional chambers 33, such that each sectional control valve 50 selectively controls fluid communication between the corresponding sectional chamber 33 and the main chamber 32, thereby achieving sectional multi-stage water control functionality.

The base 10 is configured to support and position the oscillation controller 20 and the water spray assembly 30. When the water spray assembly 30 is driven by the oscillation controller 20 to perform reciprocating oscillation, Embodiment 1 can be stably positioned within an area requiring irrigation or sprinkling.

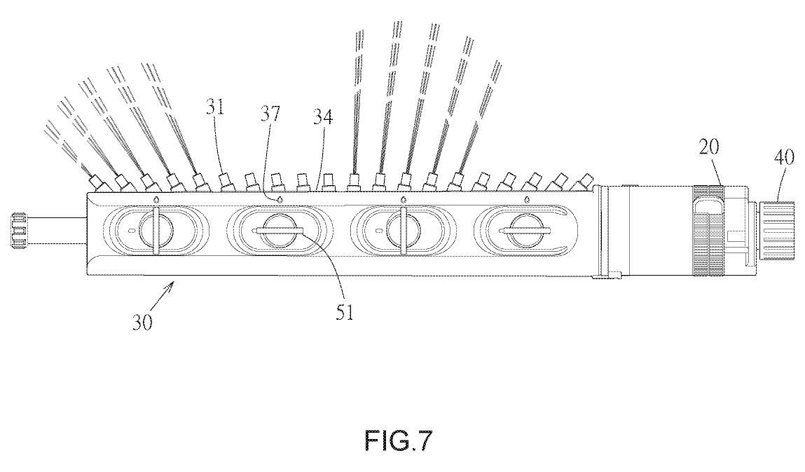

As shown in FIG. 7, the sectional chambers 33 are selectively brought into communication with the main chamber 32 through the sectional control valves 50, thereby forming a plurality of independently controllable spray zones. Each sectional control valve 50 controls whether water is discharged from, and optionally the flow rate of water discharged from, the plurality of nozzles 31 communicating with the corresponding sectional chamber 33. Accordingly, diverse spraying requirements may be satisfied, such as selectively enabling one or more groups of nozzles 31, including adjacent or non-adjacent nozzle groups. Because each sectional control valve 50 independently controls a plurality of nozzles 31, the total number of sectional control valves 50 required is reduced. As a result, nozzle distribution density is not adversely affected by spatial constraints imposed by valve size, thereby maintaining a desired spray coverage density.

The water spray assembly 30 includes a tubular outer cover 34 and a tubular inner body 35. One end of the outer cover 34 is pivotally connected to the base 10. The inner body 35 is disposed within and connected to the outer cover 34. The inner body 35 communicates with the oscillation controller 20 and defines the main chamber 32. The inner body 35 and the outer cover 34 cooperate to define the sectional chambers 33. The plurality of nozzles 31 are provided on the outer cover 34.

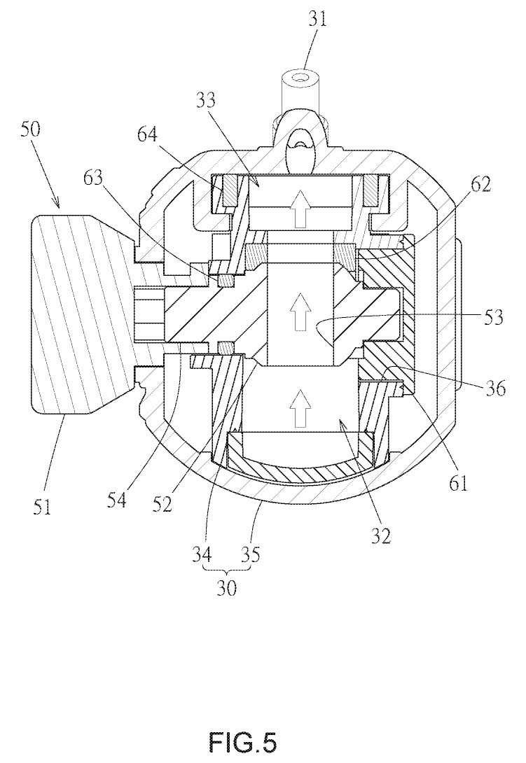

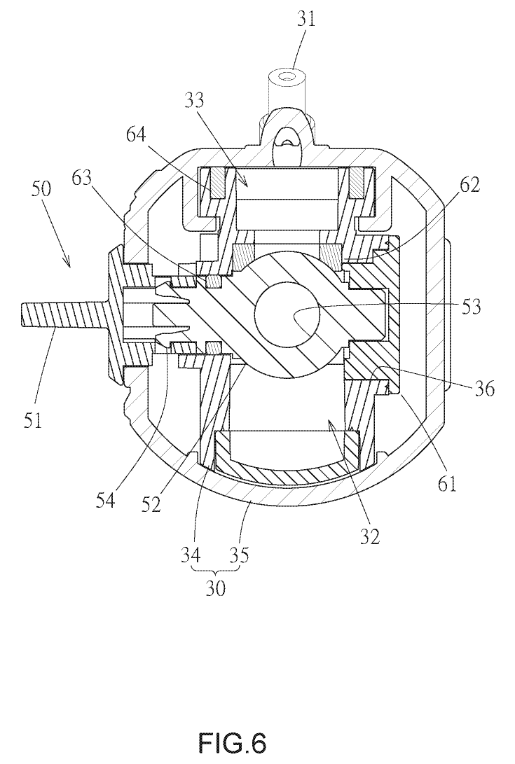

Each sectional control valve 50 includes a first operating knob 51 configured to rotate the sectional control valve 50 between a first state and a second state. Each first operating knob 51 is disposed on one side of the outer cover 34. As shown in FIG. 5, when the first operating knob 51 is in the first state, the main chamber 32 is placed in fluid communication with the corresponding sectional chamber 33 through the sectional control valve 50, such that water is discharged through the corresponding nozzles 31. As shown in FIG. 6, when the first operating knob 51 is in the second state, the sectional control valve 50 blocks communication between the main chamber 32 and the corresponding sectional chamber 33, thereby preventing water discharge through the corresponding nozzles 31.

Each sectional control valve 50 includes a ball valve body 52 pivotally and sealingly received within the inner body 35 so as to selectively block fluid communication between the corresponding sectional chamber 33 and the main chamber 32. Each ball valve body 52 defines a flow passage 53 extending radially therethrough for selectively communicating the corresponding sectional chamber 33 with the main chamber 32. Each ball valve body 52 further forms a first coupling portion 54 operatively connected to the first operating knob 51, such that rotation of the first operating knob 51 drives rotation of the ball valve body 52 to control the communication state.

The inner body 35 laterally defines a plurality of valve receiving bores 36. Each first operating knob 51 and the corresponding valve receiving bore 36 are disposed on opposite sides of the inner body 35. Each valve receiving bore 36 corresponds to one sectional control valve 50, and an inner diameter of each valve receiving bore 36 corresponds to an outer diameter of the ball valve body 52 to facilitate insertion and assembly thereof.

A plurality of retaining caps 61 are connected to the inner body 35, each retaining cap 61 closing one of the valve receiving bores 36 and pivotally retaining a corresponding ball valve body 52, thereby positioning and supporting the corresponding sectional control valve 50.

The inner body 35 is provided with a plurality of annular first sealing members 62 and second sealing members 63. Each first sealing member 62 is disposed between one ball valve body 52 and the corresponding sectional chamber 33 and elastically abuts the ball valve body 52 and the inner body 35. Each second sealing member 63 is sleeved around one sectional control valve 50 between the ball valve body 52 and the corresponding first operating knob 51 and elastically abuts the ball valve body 52, the first operating knob 51, and the inner body 35.

The inner body 35 further includes a plurality of annular third sealing members 64 disposed on a side of each sectional chamber 33 facing the outer cover 34, each third sealing member 64 elastically abutting the inner body 35 and the outer cover 34 to prevent leakage therebetween.

The outer cover 34 is provided with a plurality of section indicator markings 37 corresponding respectively to the sectional control valves 50 and the associated nozzles 31, thereby facilitating user identification of the spray coverage range controlled by each sectional control valve 50.

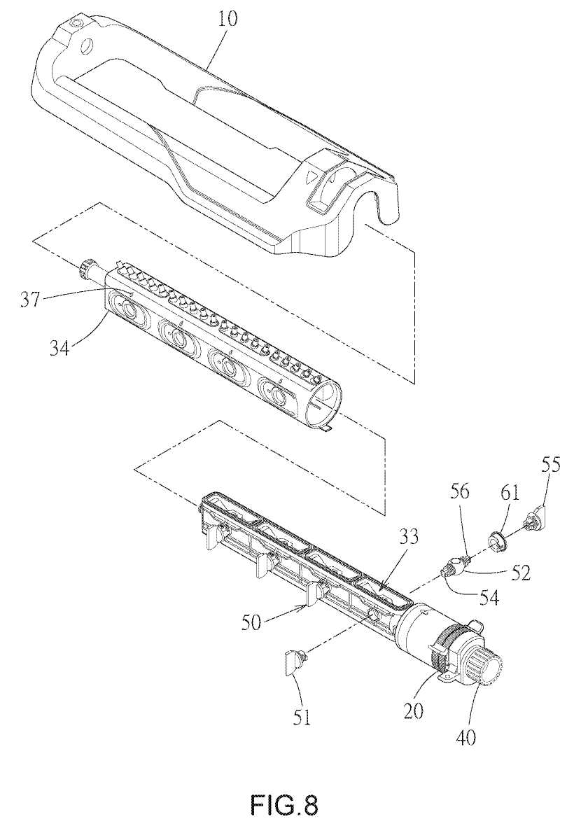

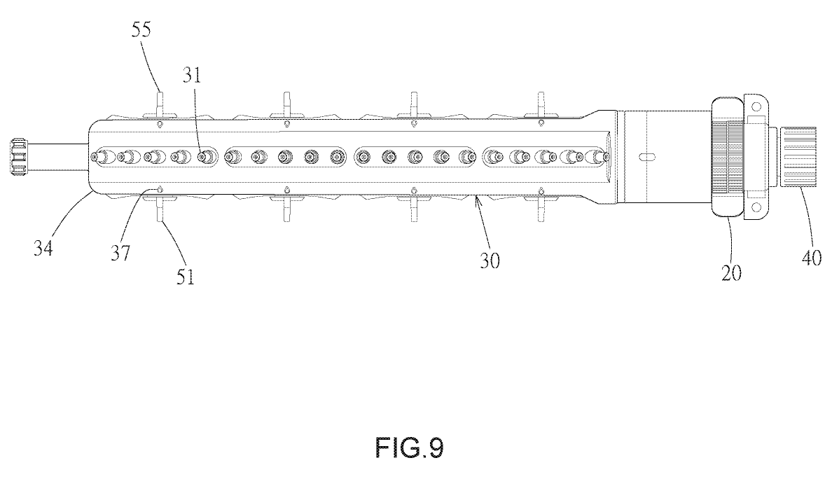

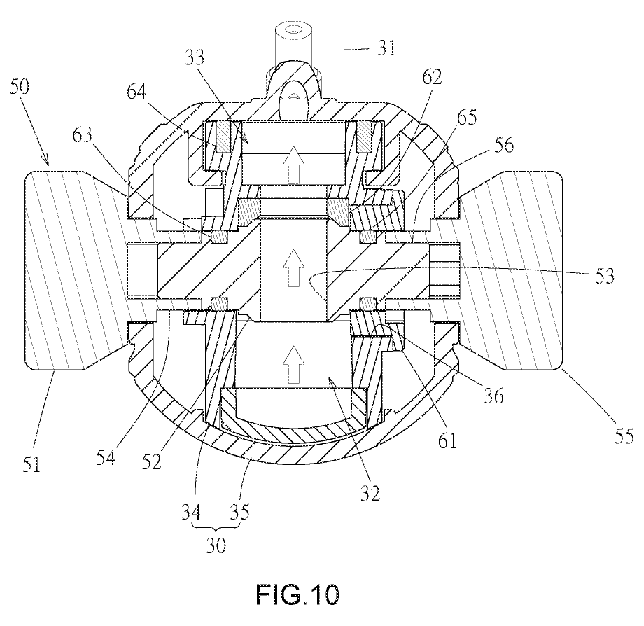

As shown in FIGS. 8 through 10, Embodiment 2 differs from Embodiment 1 primarily in that each sectional control valve 50 further includes a second operating knob 55 for rotating the sectional control valve 50. Each second operating knob 55 is disposed on the outer cover 34. Each ball valve body 52 further forms a second coupling portion 56 extending through the corresponding retaining cap 61 and connected to the second operating knob 55, such that rotation of the second operating knob 55 drives rotation of the ball valve body 52 to control communication between the corresponding sectional chamber 33 and the main chamber 32.

The inner body 35 further includes a plurality of annular fourth sealing members 65 corresponding respectively to the second operating knobs 55. Each fourth sealing member 65 is sleeved around one sectional control valve 50 between the ball valve body 52 and the corresponding second operating knob 55 and elastically abuts the ball valve body 52, the second operating knob 55, and the inner body 35.

1. A sprinkler structure with multi-stage water control, comprising:
a base;
an oscillation controller detachably connected to the base and connected to an inlet connector configured to connect to a water supply conduit for introducing a water flow, the oscillation controller being configured to generate a reciprocating oscillation by utilizing water pressure of the water flow;
a water spray assembly having a first end assembled to and driven by the oscillation controller and a second end pivotally connected to the base, the water spray assembly being provided with a plurality of nozzles spaced along an extending direction thereof;
the water spray assembly defining a main chamber, one end of the main chamber communicating with the inlet connector through the oscillation controller, and a plurality of sectional chambers spaced along the extending direction of the water spray assembly, each sectional chamber communicating with a plurality of adjacent nozzles; and
a plurality of sectional control valves respectively disposed on the water spray assembly, each sectional control valve being located between the main chamber and a corresponding one of the sectional chambers, such that each sectional control valve selectively controls fluid communication between the corresponding sectional chamber and the main chamber, thereby achieving sectional multi-stage water control.

2. The sprinkler structure with multi-stage water control according to claim 1, wherein the water spray assembly comprises a tubular outer cover and a tubular inner body, one end of the outer cover being pivotally connected to the base, the inner body being disposed inside and connected to the outer cover, the inner body communicating with the oscillation controller and defining the main chamber, the inner body and the outer cover cooperating to define the sectional chambers, each nozzle being disposed on the outer cover, and each sectional control valve including a first operating knob configured to rotate the sectional control valve, each first operating knob being disposed on one side of the outer cover.

3. The sprinkler structure with multi-stage water control according to claim 2, wherein each sectional control valve includes a ball valve body pivotally and sealingly received in the inner body to selectively block fluid communication between the corresponding sectional chamber and the main chamber, each ball valve body defining a flow passage extending radially therethrough for selectively communicating the corresponding sectional chamber with the main chamber, each ball valve body forming a first coupling portion operatively connected to the first operating knob to enable rotation-driven control of the communication state, the inner body laterally defining a plurality of valve receiving bores, each first operating knob and a corresponding one of the valve receiving bores being disposed on opposite sides of the inner body, each valve receiving bore corresponding to one sectional control valve and having an inner diameter corresponding to an outer diameter of the ball valve body, and a plurality of retaining caps connected to the inner body, each retaining cap closing one valve receiving bore and pivotally retaining a corresponding ball valve body to position the sectional control valves.

4. The sprinkler structure with multi-stage water control according to claim 3, wherein the inner body includes a plurality of annular first sealing members and a plurality of annular second sealing members, each first sealing member being disposed between one ball valve body and the corresponding sectional chamber and elastically abutting the ball valve body and the inner body, and each second sealing member being sleeved around one sectional control valve between the ball valve body and the corresponding first operating knob and elastically abutting the sectional control valve and the inner body.

5. The sprinkler structure with multi-stage water control according to claim 3, wherein each sectional control valve further includes a second operating knob configured to rotate the sectional control valve, each second operating knob being disposed on the outer cover, and each ball valve body forming a second coupling portion extending through the corresponding retaining cap and operatively connected to the second operating knob, such that rotation of the second operating knob controls communication between the corresponding sectional chamber and the main chamber.

6. The sprinkler structure with multi-stage water control according to claim 5, wherein the inner body includes a plurality of annular first sealing members, a plurality of annular second sealing members, and a plurality of annular fourth sealing members, each first sealing member being disposed between one ball valve body and the corresponding sectional chamber and elastically abutting the ball valve body and the inner body, each second sealing member being sleeved around one sectional control valve between the ball valve body and the corresponding first operating knob and elastically abutting the sectional control valve and the inner body, and each fourth sealing member being sleeved around one sectional control valve between the ball valve body and the corresponding second operating knob and elastically abutting the sectional control valve and the inner body.

7. The sprinkler structure with multi-stage water control according to claim 2, wherein the inner body includes a plurality of annular third sealing members disposed on a side of each sectional chamber facing the outer cover, each third sealing member elastically abutting the inner body and the outer cover.

8. The sprinkler structure with multi-stage water control according to claim 1, wherein the outer cover includes a plurality of section indicator markings corresponding respectively to the sectional control valves, each section indicator marking corresponding to the plurality of nozzles controlled by the respective sectional control valve, thereby facilitating identification of a spray coverage range controlled by each sectional control valve.
